(19) United States
(12) Patent Application Publication
(10) Pub. No.: US 2009/0091934 A1
(43) Pub. Date: Apr. 9, 2009

(54) High power LED module

(75) Inventor: Tsai-Chieh Lin, Lotung Town (TW)

Correspondence Address: BACON & THOMAS, PLLC, 625 SLATERS LANE, FOURTH FLOOR, ALEXANDRIA, VA, 22314-1176, US

(73) Assignee: COSMO ELECTRONICS CORPORATION, Yilan Hsien (TW)

(21) Appl. No.: 11/905,864

(22) Filed: Oct. 5, 2007

(51) Int. Cl. F21V 29/00

(52) U.S. Cl. 362/294

(57) ABSTRACT

A high power LED module includes a substrate formed of a metal bottom thermal transfer plate coated with an insulative layer and having a plurality of electric contacts formed on the metal bottom thermal transfer plate and exposed to the outside of the insulative layer and a plurality of bonding holes cut through the top and bottom sides, epitaxial chips installed in a center area of the substrate and electrically connected to the electric contacts, and a frame injection-molded on the substrate around the at least one epitaxial chip and having a plurality of bonding legs bonded to the bottom bonding holes of the substrate.

### BACKGROUND OF THE INVENTION

1. Field of the Invention

The present invention relates generally to LED (light emitting diode) modules and more particularly, to a high power LED module, which has a frame directly molded on the substrate to protect the epitaxial chips that are bonded to the substrate and to facilitate dissipation of heat, and a semispherical light-transmission cover covered on the frame to enhance the brightness.

2. Description of the Related Art

Following fast development of semiconductor technology, a variety of high-tech products are developed and used in our daily life, bringing convenience to people. High technology has also been intensively employed to improve products. For example, from early oil lamp that uses a fuel source to produce light continuously for a period of time and carbamide lamp to the modern incandescent lamp, fluorescent lamp, quartz lamp, halogen lamp and LEDs (light emitting diodes), we can see the progress of technology.

Nowadays, LEDs have been intensively used in different fields to substitute for conventional lamp bulbs. For example, many traffic and signal lights use LEDs instead of conventional lamp bulbs for the advantages of low consumption of electric power, long service life, quick start, pollution-free, reclaimability, low cost, high strength and low heat. Many people invest their money to the research and development of LEDs.

However, regular LEDs are not suitable for illumination because of the drawbacks of low brightness and dispersion of light. There are manufacturers providing high power LEDs. High power LEDs have high brightness. However, they produce much heat during operation, resulting in short service life. Therefore, many improvement measures are created.

FIGS. 5 and 6 show a LED module according to the prior art. According to this design, the LED module is comprised of a heat sink A, a thermal transfer substrate B, a packaging adhesive C and a retainer ring D. The substrate B has a reflecting slot B1 at the center. Chips B11 are bonded to the inside of the reflecting slot B1 and electrically connected to the circuits B2 on the top surface of the substrate B with lead wires B111. The packaging adhesive C is fastened to the reflecting slot B1. The retaining ring D is bonded to the top side of the substrate B and the border of the top side of the packaging adhesive C. During fabrication, the chips B11 are installed in the reflecting slot B1, and then a wire bonding machine is used to electrically connect the chips B11 to the circuits B2 on the top surface of the substrate B. Thereafter, the packaging adhesive C is filled in the reflecting slot B1 to affix the chips B11 and the lead wires B111 to the substrate B, and then the retaining ring D is bonded to the substrate B and the packaging adhesive C. At final, the substrate B is fixedly fastened to the top wall of the heat sink A.

During operation of the aforesaid LED module, the substrate B transfer heat energy from the chips B11 to the heat sink A for dissipation. However, this design of LED module still has drawbacks as follows:

1. The substrate B must be cut to provide the reflecting slot B1. Because the substrate B has a limited thickness, it is complicated and difficult to make the reflecting slot B11 on the substrate B. After formation of the reflecting slot B1, the surface of the reflecting slot B1 may be uneven, and the uneven surface of the reflecting slot B1 may result in an installation of the chips B11 and the lead wires B11 or bias the emission of light, lowering the brightness of the LED module.

2. Because the packaging adhesive C covers the chips B11, it directly receives heat energy from the chips B11. Excessive high temperature will cause the packaging adhesive C to break. When broken, the packaging adhesive C cannot well protect the chips B11 against dust and impact.

### SUMMARY OF THE INVENTION

The present invention has been accomplished under the circumstances in view. It is therefore the main object of the present invention to provide a high power LED module that eliminates the aforesaid drawbacks.

According to one aspect of the present invention, the LED module comprises a substrate, a frame, a semispherical light-transmission cover and a heat sink. The substrate comprises a metal bottom thermal transfer plate, an insulative layer coated on the top surface of the metal bottom thermal transfer plate, a plurality of electric contacts formed on the metal bottom thermal transfer plate and exposed to the outside of the insulative layer, a plurality of circuits arranged on the insulative layer and electrically connected to the electric contacts, at least one epitaxial chip installed in a center area of the substrate and electrically connected to the electric contacts, and a plurality of bonding holes cut through top and bottom sides of the substrate and spaced around the at least one epitaxial chip. The frame is injection-molded on the substrate around the at least one epitaxial chip, comprising a plurality of bottom bonding legs respectively bonded to the bonding holes of the substrate, a tapered center through hole gradually downwardly reducing in diameter, a reflecting surface formed on the periphery of the tapered center through hole, a light-transmission packaging silicon adhesive bonded to the tapered center through hole over the at least one epitaxial chip, and a light-transmission cover fastened to the top side of the frame and covered over the light-transmission packaging silicon adhesive. The heat sink is fixedly fastened to the bottom side of the substrate. Because the at least one epitaxial chip and the lead wires are arranged on a flat surface at the substrate and because the light-transmission packaging silicon adhesive is directly bonded to the frame and the substrate to affix the at least one epitaxial chip and the lead wires, the epitaxial chip and the lead wires are kept in position. During operation of the LED module, the reflecting surface reflects light from the at least one epitaxial chip toward the light-transmission packaging silicon adhesive and the semispherical light-transmission cover, so that the semispherical light-transmission cover refracts reflected light toward the outside, enhancing the brightness.

Because the invention needs not to make a slot on the top side of the substrate for accommodating the at least one epitaxial chip and the lead wires, the circuits, the insulative layer and the electric contacts can be respectively formed on the smooth top surface of metal bottom thermal transfer plate through a respective single-step processing process.

Further, the at least one epitaxial chip is installed in the substrate within the tapered center through hole of the frame. During operation of the LED module, heat energy is quickly transferred by the metal bottom thermal transfer plate of the substrate to the heat sink and then dissipated into the outside open air, therefore the light-transmission packaging silicon adhesive is constantly kept intact to effectively protect the at least one epitaxial chip against dust and impact.

### BRIEF DESCRIPTION OF THE DRAWINGS

FIG. 1 is a perspective view of a high power LED module in accordance with the present invention.

FIG. 2 is an exploded view of the high power LED module in accordance with the present invention.

FIG. 3 is a sectional side view of the high power LED module in accordance with the present invention.

FIG. 4 is a sectional side view of an alternate form of the high power LED module in accordance with the present invention.

FIG. 5 is an exploded view of a LED module according to the prior art.

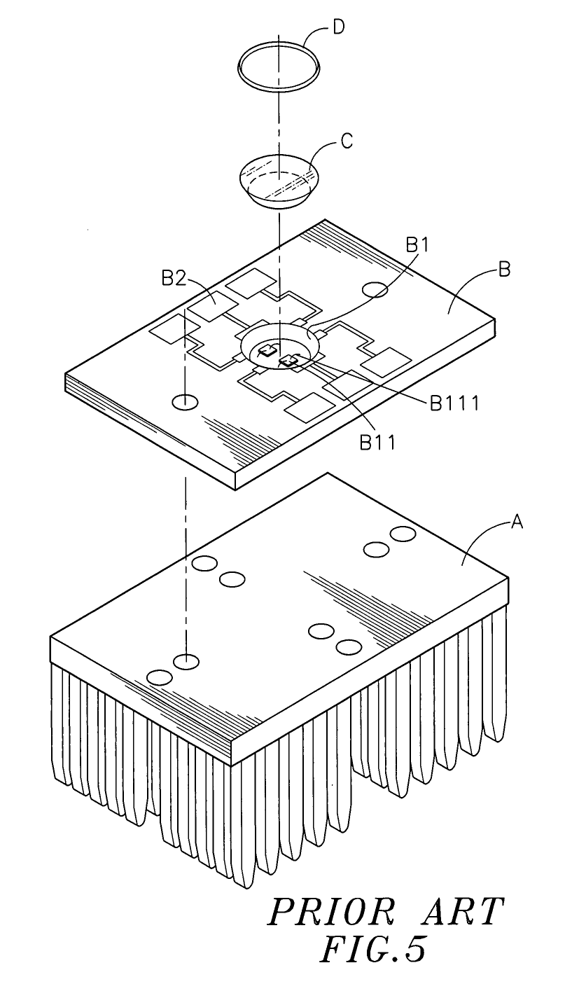

FIG. 6 is a sectional side view of the LED module according to the prior art.

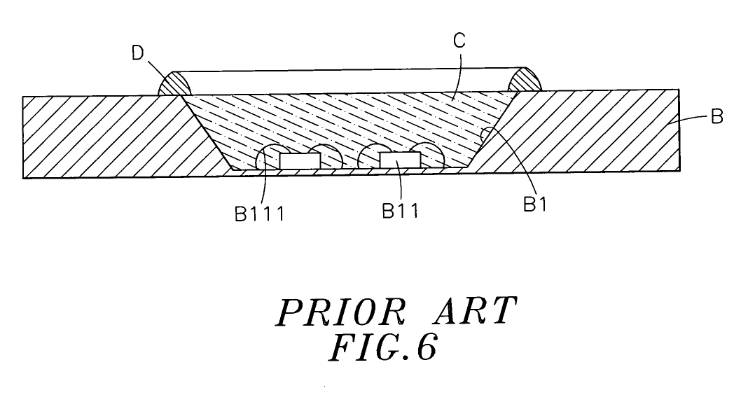

### DETAILED DESCRIPTION OF THE INVENTION

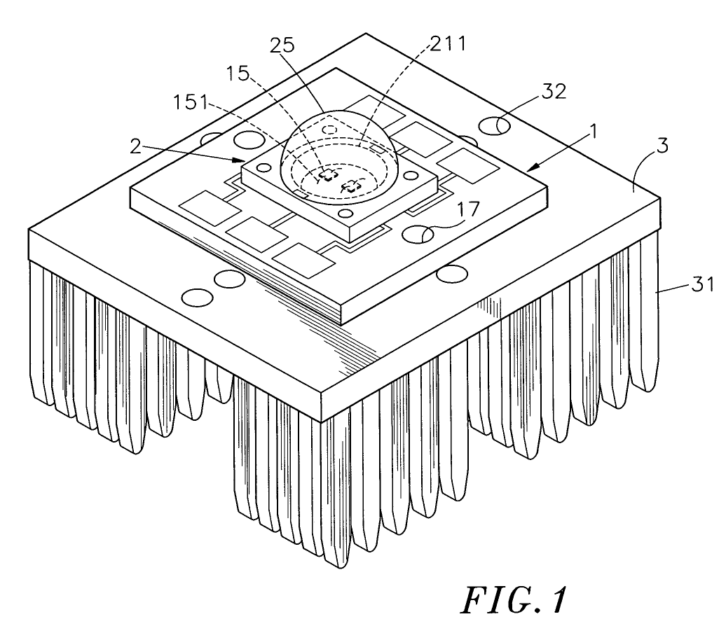

Referring to FIGS. 1-3, a LED (light emitting diode) module in accordance with the present invention is shown comprising a substrate 1, a frame 2 and a heat sink 3.

The substrate 1 comprises a metal bottom thermal transfer plate 11, an insulative layer 12 prepared from epoxy resin and covered on the top surface of the metal bottom thermal transfer plate 11, a plurality of electric contacts 14 formed on the top surface of the metal bottom thermal transfer plate 11 and exposed to the outside of the insulative layer 12, a plurality of circuits 13 formed on the insulative layer 12 and electrically connected to the electric contacts 14, a thermal transfer zone 141 defined at the center area of the substrate 1, a plurality of epitaxial chips 15 mounted in the thermal transfer zone 141, a plurality of lead wires 151 respectively extended from two opposite sides of each of the epitaxial chips 15 and connected to the electric contacts 14 at the center area of the substrate 1 around the epitaxial chips 15, a plurality of bonding holes 16 vertically cut through the insulative layer 12 and the metal bottom thermal transfer plate 11 and spaced around the thermal transfer zone 141, and two mounting screw holes 17 vertically cut through the insulative layer 12 and the metal bottom thermal transfer plate 11 at two sides. The metal bottom thermal transfer plate 11 can be prepared from, for example, silver-plated copper.

The frame 2 is a rectangular block member injection-molded from LCP (liquid crystal polymer) or any other suitable electrically insulative materials, having a tapered center through hole 21 that gradually reduces in diameter from the top side of the frame 2 toward its bottom side, a smooth reflecting surface 211 formed on the peripheral wall of the tapered center through hole 21, and a plurality of bottom bonding legs 22 downwardly extending from the bottom side in the corners, two retaining holes 23 formed in the top wall at two sides of the tapered center through hole 21. Further, a light-transmission packaging adhesive 24 is prepared from silicon and bonded to the frame 2 to fill up the tapered center through hole 21. A semispherical light-transmission cover 25 covered on the top side of the frame 2 over the light-transmission packaging adhesive 24. The semispherical light-transmission cover 25 has two bottom hooks 251 respectively hooked in the retaining holes 23 of the frame 2.

The heat sink 3 is extruded from aluminum, having a plurality of radiating elements 31 downwardly extending from the bottom wall, and a plurality of mounting holes 32 on the top side.

During fabrication, the frame 2 is directly molded on the top side of the substrate 1. After molding, the bottom bonding legs 22 are formed and bonded to the bonding holes 16 of the substrate 1. Thereafter, the light-transmission packaging adhesive 24 is bonded to the tapered center through hole 21 of the frame 2 and the thermal transfer zone 141 of the substrate 1 over the epitaxial chips 15 by mean of a packaging technique, and then the semispherical light-transmission cover 25 is covered on the top side of the frame 2 over the light-transmission packaging adhesive 24 with its bottom hooks 251 respectively hooked in the retaining holes 23 of the frame 2. Then, the substrate 1 with the frame 2 is fixed fastened to the heat sink 3.

The metal bottom thermal transfer plate 11 of the substrate 1 is prepared from a thermal conductivity material such as copper or aluminum. The epitaxial chips 151 are installed in the thermal transfer zone 141 in the electric contact 14 at the center area of the substrate 1, and the lead wires 151 of the epitaxial chips 151 are respectively and electrically connected to the circuits 13. The insulative layer 12 may cover or may not cover the thermal zone 141. However, the installation of the insulative layer 12 does not interfere with transfer of heat from the epitaxial chips 151 to the heat sink 3.

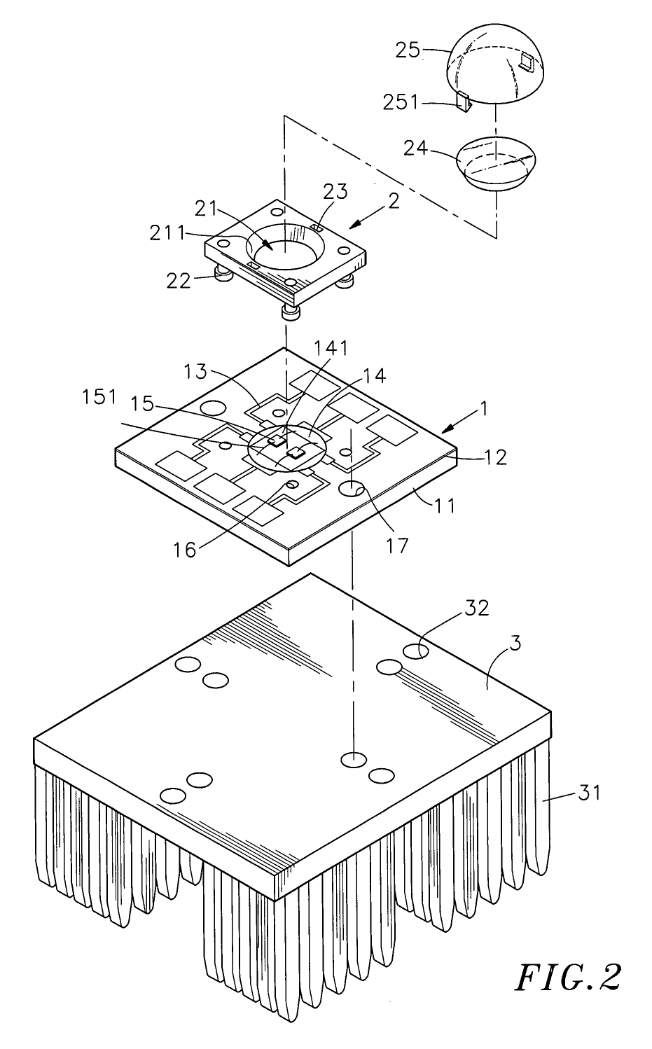

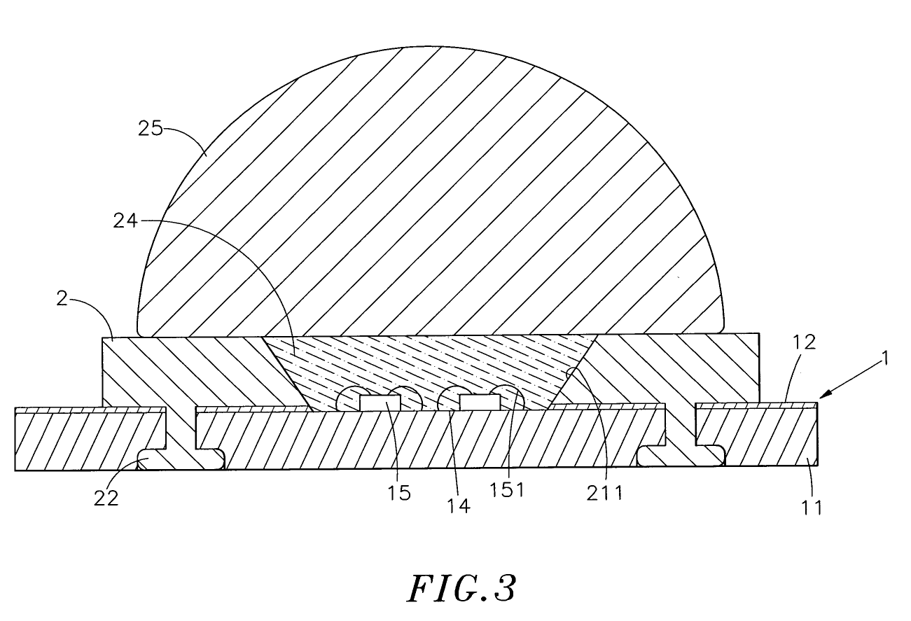

Referring to FIGS. 2 and 3 again, after formation of the frame 2 on the substrate 1 by means of injection molding, the epitaxial chips 151 are disposed in the tapered center through hole 21, the light-transmission packaging adhesive 24 is bonded to the thermal transfer zone 141 of the substrate 1 over the epitaxial chips 15 to fill up the tapered center through hole 21 of the frame 2, and the semispherical light-transmission cover 25 is covered on the top side of the frame 2 over the light-transmission packaging adhesive 24 with its bottom hooks 251 respectively hooked in the retaining holes 23 of the frame 2. When the epitaxial chips 15 are turned on to emit light, the reflecting surface 211 reflects light from the epitaxial chips 15 toward the light-transmission packaging adhesive 24 and the semispherical light-transmission cover 25, so that the semispherical light-transmission cover 25 refracts reflected light toward the outside, enhancing the brightness.

Further, the semispherical light-transmission cover 25 can be injection-molded from a light-transmission material. Therefore, the fabrication of the semispherical light-transmission cover 25 is simple and inexpensive. By means of forcing the bottom hooks 251 into the retaining holes 23 of the frame 2, the semispherical light-transmission cover 25 is quickly installed in the frame 2.

Further, the insulative layer 12, the circuits 13 and the electric contacts 14 can be formed on the flat surface of the metal bottom thermal transfer plate 11 by means of a printing technique or any suitable single-step processing process.

Further, when the light-transmission packaging adhesive 24 is bonded to the thermal transfer zone 141 of the substrate 1 over the epitaxial chips 15 to fill up the tapered center through hole 21 of the frame 2, the light-transmission packaging adhesive 24 simultaneously bonds the epitaxial chips 15 to the substrate 1. During operation of the epitaxial chips 15, heat energy is transferred from the epitaxial chips 15 to the heat sink 3 through the metal bottom thermal transfer plate 11 and then dissipated into the outside open air by the radiating elements 31. Because heat energy is quickly carried away from the epitaxial chips 15 during operation, the service life of the epitaxial chips 15 is greatly prolonged.

The aforesaid heat sink 3 can be prepared from aluminum, copper, graphite or any other suitable thermal transfer materials. The radiating elements 31 of the heat sink 3 can be radiating fins or bars for quick dissipation of heat transferred from the epitaxial chips 15 through the metal bottom thermal transfer plate 11 of the substrate 1 to the head sink 3.

Further, the light-transmission packaging adhesive 24 is bonded to the thermal transfer zone 141 of the substrate 1 over the epitaxial chips 15 to fill up the tapered center through hole 21 of the frame 2. When the metal bottom thermal transfer plate 11 of the substrate 1 is transferring heat energy from the epitaxial chips 15 to the head sink 3, a part of heat energy may be simultaneously transferred to the light-transmission packaging adhesive 24. At this time, the frame 2 dissipates heat energy from the light-transmission packaging adhesive 24. Further, because the bottom bonding legs 22 of the frame 2 are bonded to the bonding holes 16 of the substrate 1 and disposed in contact with the top wall of the heat sink 3, the frame 2 can also transfer heat energy to the heat sink 3 for dissipation to lower the temperature of the light-transmission packaging adhesive 24 and the epitaxial chips 15, preventing the light-transmission packaging adhesive 24 from breaking. Therefore, the light-transmission packaging adhesive 24 can effectively protect the epitaxial chips 15 against dust and impact.

The aforesaid frame 2 and the light-transmission cover 25 can be made having any of a variety of shapes. The frame 2 is provided for receiving the light-transmission packaging adhesive 24 to package the epitaxial chips 15 and the lead wires 151. The light-transmission cover 25 protects the light-transmission packaging adhesive 24, and correct light form and angle. According to the present preferred embodiment, the light-transmission cover 25 is fastened to the frame 2 by means of hooking the bottom hooks 251 into the retaining holes 23 of the frame 2. Other measures may be employed to fasten the light-transmission cover 25 to the frame 2.

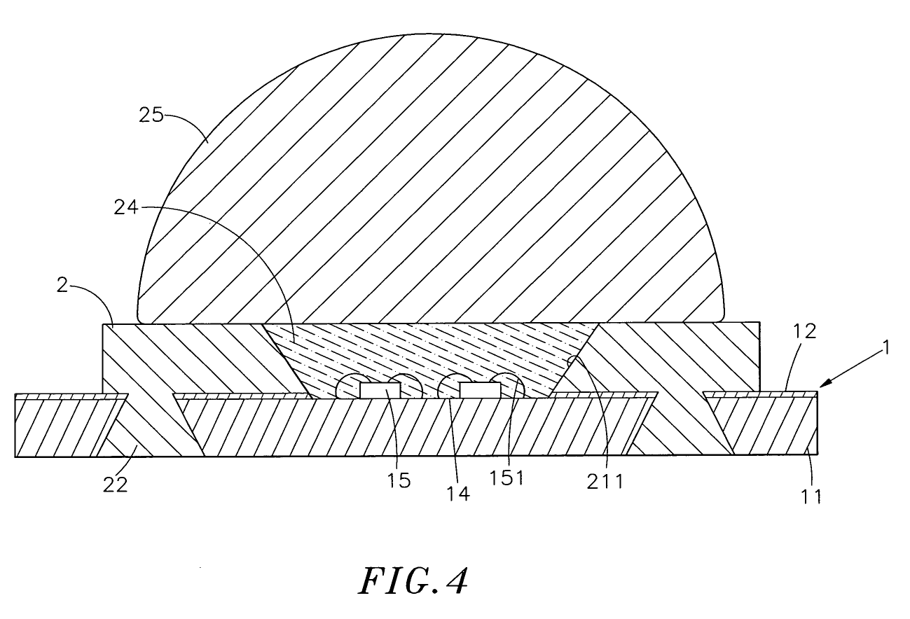

Referring to FIGS. 3 and 4 again, the bonding holes 16 have an invertedly disposed T-shaped profile (see FIG. 3). Alternatively, the bonding holes 16 can be tapered, having a diameter gradually increasing from the top side toward the bottom side (see FIG. 4). The bottom bonding legs 22 of the frame 2 fit the bonding holes 16 in shape. After installation, the frame 2 is firmly secured to the substrate 1 and disposed in close contact with the heat sink 3. Therefore, the frame 2 can transfer heat energy from the epitaxial chips 15 to the heat sink 3.

As stated above, the high power LED module of the present invention has the following features and advantages:

1. The frame 2 is injection-molded on the substrate 1, having metal bonding legs 22 directly bonded to the bonding holes 16 of the substrate 1 and a smooth reflecting surface 211 formed on the peripheral wall of the tapered center through hole 21 thereof for reflecting light from the epitaxial chips 15 in the tapered center through hole 21 toward the light-transmission cover 25, so that the semispherical light-transmission cover 25 refracts reflected light toward the outside to enhance the brightness.

2. The substrate 1 needs not to provide a recessed hole for accommodating the epitaxial chips 15. Therefore, the insulative layer 12, the circuits 13 and the electric contacts 14 can respectively and easily be formed on the smooth top surface of the metal bottom thermal transfer plate 11 through one single processing step.

3. The smooth top surface of the metal bottom thermal transfer plate 11 facilitates arrangement of the epitaxial chips 15 and the lead wires 151, and the bottom of each epitaxial chip 15 can be fully bonded to the top surface of the metal bottom thermal transfer plate 11 for quick dissipation of heat through the heat sink 3.

4. After installation of the epitaxial chips 15 in the tapered center through hole 21 of the frame 2, heat energy can rapidly be transferred from the epitaxial chips 15 to the metal bottom thermal transfer plate 11 for quick dissipation of heat through the heat sink 3. Therefore, the light-transmission packaging adhesive 24 does not break and can effectively protect the epitaxial chips 15 against dust and impact and work with the light-transmission cover 25 to correct light form and angle.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A light emitting diode module comprising
a substrate, said substrate comprising a metal bottom thermal transfer plate, an insulative layer coated on a top surface of said metal bottom thermal transfer plate, a plurality of electric contacts formed on said metal bottom thermal transfer plate and exposed to the outside of said insulative layer, at least one epitaxial chip installed in a center area of said substrate and electrically connected to said electric contacts, and a plurality of bonding holes cut through top and bottom sides of said substrate and spaced around said at least one epitaxial chip; and
a frame injection-molded on said substrate around said at least one epitaxial chip, said frame comprising a plurality of bonding legs respectively bonded to said bonding holes of said substrate.

2. The light emitting diode module as claimed in claim 1, wherein said metal bottom thermal transfer plate is prepared from silver-plated copper.

3. The light emitting diode module as claimed in claim 1, wherein said insulative layer is prepared from epoxy resin.

4. The light emitting diode module as claimed in claim 1, wherein said substrate further comprises a plurality of circuits arranged on said insulative layer and electrically connected to said electric contacts and said at least one epitaxial chip.

5. The light emitting diode module as claimed in claim 1, wherein said substrate comprises a thermal transfer zone at said center area thereof; said at least one epitaxial chip is installed in said thermal transfer zone and electrically connected to said electric contacts with lead wires.

6. The light emitting diode module as claimed in claim 1, wherein said frame is a rectangular block member molded from liquid crystal polymers.

7. The light emitting diode module as claimed in claim 1, wherein said frame comprises a tapered center through hole gradually downwardly reducing in diameter, a reflecting surface formed on periphery of said tapered center through hole, and a light-transmission packaging silicon adhesive bonded to said tapered center through hole over said at least one epitaxial chip.

8. The light emitting diode module as claimed in claim 1, wherein said bonding legs of said frame extend downwardly from a bottom side of said frame in corners of said frame.

9. The light emitting diode module as claimed in claim 1, further comprising a light-transmission cover covered on a top side of said frame.

10. The light emitting diode module as claimed in claim 9, wherein said frame comprises a plurality of retaining holes; said light-transmission cover comprises a plurality of bottom hooks respectively hooked in said retaining holes of said frame.

11. The light emitting diode module as claimed in claim 1, further comprising a heat sink fixedly fastened to a bottom surface of said metal bottom thermal transfer plate of said substrate.

12. The light emitting diode module as claimed in claim 11, wherein said heat sink is extruded from aluminum, comprising a plurality of radiating elements downwardly extending from a bottom side thereof.

13. The light emitting diode module as claimed in claim 11, wherein said bonding holes of said substrate have an inverted disclosed T-shaped profile; said bonding legs of said frame is bonded to said bonding holes of said substrate and disposed in contact with said heat sink.

14. The light emitting diode module as claimed in claim 11, wherein said bonding holes of said substrate can be tapered, having a diameter gradually increasing from the top side toward the bottom side; said bonding legs of said frame is bonded to said bonding holes of said substrate and disposed in contact with heat sink.
